(19) United States
(12) Patent Application Publication
(10) Pub. No.: US 2013/0340256 A1
(43) Pub. Date: Dec. 26, 2013

(54) BEARING REPLACEMENT METHOD AND TOOLS FOR ROTATING MACHINE

(71) Applicant: Hitachi, Ltd., Tokyo (JP)

(72) Inventors: Osamu TSUCHITANI, Hitachi (JP); Motonobu IIZUKA, Hitachi (JP); Shuji MIZUTANI, Hitachinaka (JP); Tetsuo FUJIGAKI, Hitachi (JP); Masaaki ENDO, Hitachi (JP); Yoshihiro YASUI, Hitachi (JP); Shogo SERITA, Hitachi (JP); Masakazu SHINDEN, Hitachi (JP)

(21) Appl. No.: 13/920,203

(22) Filed: Jun. 18, 2013

(30) Foreign Application Priority Data
Jun. 21, 2012 (JP) 2012-139327

(51) Int. Cl. F16C 35/06; F03D 11/00

(52) U.S. Cl. CPC F16C 35/062; F03D 11/0008
USPC 29/898.06; 29/724

(57) ABSTRACT

A bearing replacement method for a rotating machine of the present invention includes the steps of: when at least one bearing of a rotating machine is to be replaced with a new one, mounting at an end portion of the rotating machine a plurality of bendable arms for removing a first bearing covering part, a power supply unit outer frame, and a slipring, respectively; removing with the arms the first bearing covering part, the power supply unit outer frame, and the slipring, respectively; and thereafter replacing the at least one bearing with a new one.

### BACKGROUND OF THE INVENTION

1. Field of the Invention

The present invention relates generally to bearing replacement methods for rotating machines and disassembling apparatuses for bearing replacement. The invention more particularly relates to a bearing replacement method for a rotating machine and a disassembling apparatus for the bearing replacement suitable for replacing a bearing in, for example, a generator housed in a nacelle mounted at an upper portion of a windmill tower.

2. Description of Related Art

A wind power station typically includes a nacelle disposed at an upper portion of a windmill tower fixed to the ground. The nacelle supports a rotor rotated by blades and houses thereinside a generator driven by rotation of the blades and other devices.

In recent years, the introduction of wind power generation is on the increase with a resultant requirement for ease of maintenance in the entire wind power stations.

The generator, in particular, housed in the nacelle installed at the upper portion of the windmill tower includes a bearing for removably supporting a rotor. When this bearing fails, a crane must be used to lower the generator from the nacelle for replacement of the faulty bearing. The bearing replacement work using the crane, however, entails an enormous amount of cost and maintenance time.

Meanwhile, offshore, instead of onshore, building of wind power station installation sites continue to expand. Considering the bearing replacement work performed on the ocean, the cost and maintenance time will further increase for, for example, transportation and work time compared with generators of the wind power stations installed on the land.

Against this background, JP-T-2012-501400 discloses a maintenance system for a wind turbine plant, the maintenance system being capable of performing a spontaneous, prompt, and simplified maintenance procedure without requiring, for example, another external crane, when some part should require maintenance. The maintenance system disclosed in JP-T-2012-501400 includes a carriage unit disposed on an upper side inside a nacelle, the carriage unit being movable in an longitudinal direction, a trolley disposed on the carriage unit, the trolley being movable in a width direction of the nacelle, a drive pulley disposed in the trolley, and a winch unit connected to the drive pulley via a wire.

### SUMMARY OF THE INVENTION

The maintenance system disclosed in JP-T-2012-501400, including the carriage unit and the trolley disposed in the nacelle, however, needs to have a space for placing removed parts within a movable range of the maintenance system, which makes the entire nacelle large in size. The maintenance system also requires that all parts disposed at an upper portion of a part to be removed be removed, thus requiring a large amount of maintenance time.

In general, the generator of a wind power station is installed in the nacelle located at the upper portion of the windmill tower and the generator is thus located at a height of several tens of meters from the ground.

If it is impossible to replace a faulty bearing inside the nacelle, therefore, the generator needs to be demounted from the nacelle using a crane and the bearing replacement method needs to be performed on the ground. It is, however, not easy to demount the generator from the nacelle, so that the bearing replacement method using the crane entails considerably increased cost and a large amount of maintenance time.

The present invention has been made in view of the foregoing situation and it is an object of the present invention to provide a bearing replacement method for a rotating machine and a disassembling apparatus for the bearing replacement, the bearing replacement method and the disassembling apparatus being capable of a considerable reduction in cost and maintenance time.

To achieve the foregoing object, an aspect of the present invention provides a bearing replacement method for a rotating machine, the method comprising the steps of: when at least one bearing of a rotating machine is to be replaced with a new one, mounting at an end portion of the rotating machine a plurality of bendable arms for removing a first bearing covering part, a power supply unit outer frame, and a slipring, respectively; removing with the arms the first bearing covering part, the power supply unit outer frame, and the slipring, respectively; and thereafter replacing the at least one bearing with a new one.

To achieve the foregoing object, an aspect of the present invention provides a disassembling apparatus for bearing replacement, the apparatus comprising: a first maintenance jig, the first maintenance jig including: a base fixed via a rotating machine main unit frame to a seat to which a rotating machine is fixed, and disposed at an end portion of the rotating machine; a base plate fixed to the base and a lifting tab on the rotating machine main unit; and a plurality of bendable arms to be mounted on the base plate, the arms for removing a first bearing covering part, a power supply unit outer frame, and a slipring, respectively, of the rotating machine. In the disassembling apparatus, in order to replace at least one bearing of the rotating machine, the first bearing covering part, the power supply unit outer frame, and the slipring are removed using the respective arms of the first maintenance jig.

The present invention enables the bearing replacement procedure to be performed in a limited space available inside the nacelle, achieving a considerable reduction in cost and maintenance time, so that the present invention is extremely effective in the bearing replacement work of this type.

### BRIEF DESCRIPTION OF THE DRAWINGS

Other objects and advantages of the invention will become apparent from the following description of embodiments with reference to the accompanying drawings in which:

FIG. 1 is a perspective view showing a wind power generation system to which a bearing replacement method of the present invention is applied;

FIG. 2 is a cross-sectional view showing a generator constituting the wind power generation system shown in FIG. 1;

FIG. 3 is an enlarged cross-sectional view showing a portion A shown in FIG. 2;

FIG. 4 is a plan view showing a rotating machine, schematically illustrating a mounting condition of a disassembling apparatus for bearing replacement according to a first embodiment of the present invention;

FIG. 5 is a front elevational view showing a non-drive end of the rotating machine, schematically illustrating the mounting condition of the disassembling apparatus for bearing replacement according to the first embodiment of the present invention;

FIG. 6A is a diagram showing a base on the non-drive end of the rotating machine constituting the disassembling apparatus for bearing replacement according to the first embodiment of the present invention;

FIG. 6B is a diagram showing a base on a drive end of the rotating machine constituting the disassembling apparatus for bearing replacement according to the first embodiment of the present invention;

FIG. 7 is a diagram showing base plates on the drive end and the non-drive end of the rotating machine constituting the disassembling apparatus for bearing replacement according to the first embodiment of the present invention;

FIG. 8 is a diagram showing a rod incorporated in the disassembling apparatus for bearing replacement according to the first embodiment of the present invention;

FIG. 9 is a diagram showing an arm for removing a bearing covering part on the non-drive end of the rotating machine constituting the disassembling apparatus for bearing replacement according to the first embodiment of the present invention;

FIG. 10 is a diagram showing an arm for removing a power supply unit outer frame on the non-drive end of the rotating machine constituting the disassembling apparatus for bearing replacement according to the first embodiment of the present invention;

FIG. 11 is a diagram showing an arm for removing a slipring on the non-drive end of the rotating machine constituting the disassembling apparatus for bearing replacement according to the first embodiment of the present invention; and

FIG. 12 is a diagram showing an arm for removing a bearing covering part on the drive end of the rotating machine constituting the disassembling apparatus for bearing replacement according to the first embodiment of the present invention.

### DESCRIPTION OF THE PREFERRED EMBODIMENTS

A bearing replacement method for a rotating machine and a disassembling apparatus for bearing replacement according to the illustrated embodiment of the present invention will be described below. Like reference numerals refer to corresponding parts throughout the drawings.

### First Embodiment

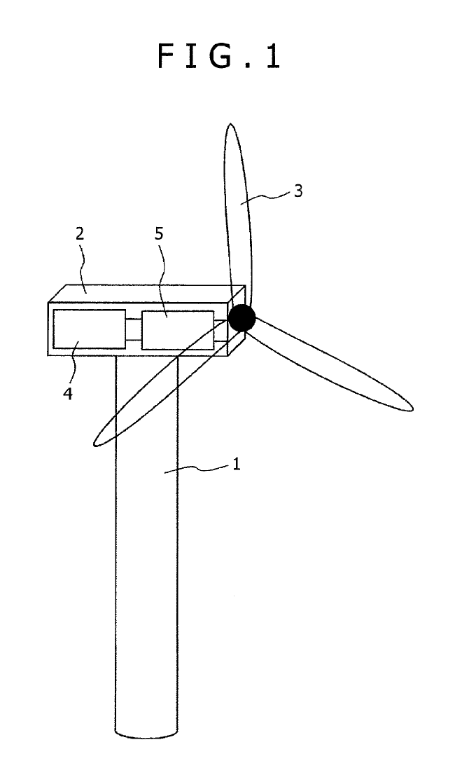

Referring to FIG. 1, a wind power generation system to which the embodiment of the present invention is applied will be described. As shown in FIG. 1, the wind power generation system generally includes a windmill tower 1, a nacelle 2 disposed at a leading end of the windmill tower 1, and blades 3 that receive wind. The nacelle 2 houses therein, for example, a generator 4 as a rotating machine and a speed-increasing gear 5.

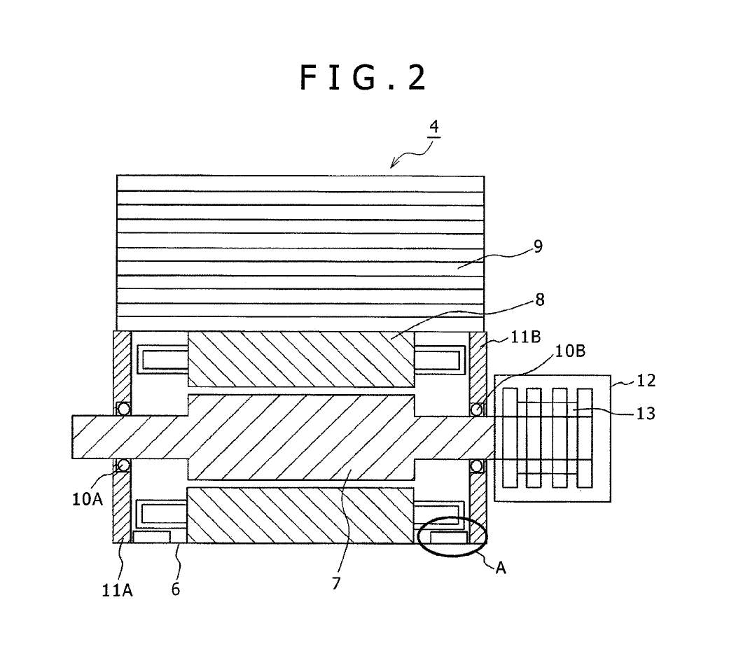

FIG. 2 shows a schematic configuration of the generator 4 housed in the nacelle 2. As shown in FIG. 2, the generator 4 generally includes a rotor 7, a stator 8, and a cooler 9. The rotor 7 and the stator 8 are housed in a main unit frame 6. The stator 8 is disposed so as to face the rotor 7 with a predetermined gap therebetween. The cooler 9 is disposed at an upper portion of the main unit frame 6. The rotor 7 has a drive end borne by a bearing 10A and a non-drive end opposite to the drive end borne by a bearing 10B. The drive end is connected to the blades 3 of a windmill as a prime mover.

If the bearing 10A or the bearing 10B fails, the faulty bearing 10A or bearing 10B needs to be replaced with a good one. The first embodiment of the present invention enables replacement of the bearing 10A or the bearing 10B to be performed inside the nacelle 2.

The first embodiment of the present invention will be described in detail below.

To replace the bearing 10B on the non-drive end, a first bearing covering part 11B that covers the bearing 10B on the non-drive end, a power supply unit outer frame 12 of the rotor 7, and a slipring 13 as a part of a power supply unit of the rotor 7 need to be removed. To replace the bearing 10A on the drive end, a second bearing covering part 11A that covers the bearing 10A on the drive end needs to be removed.

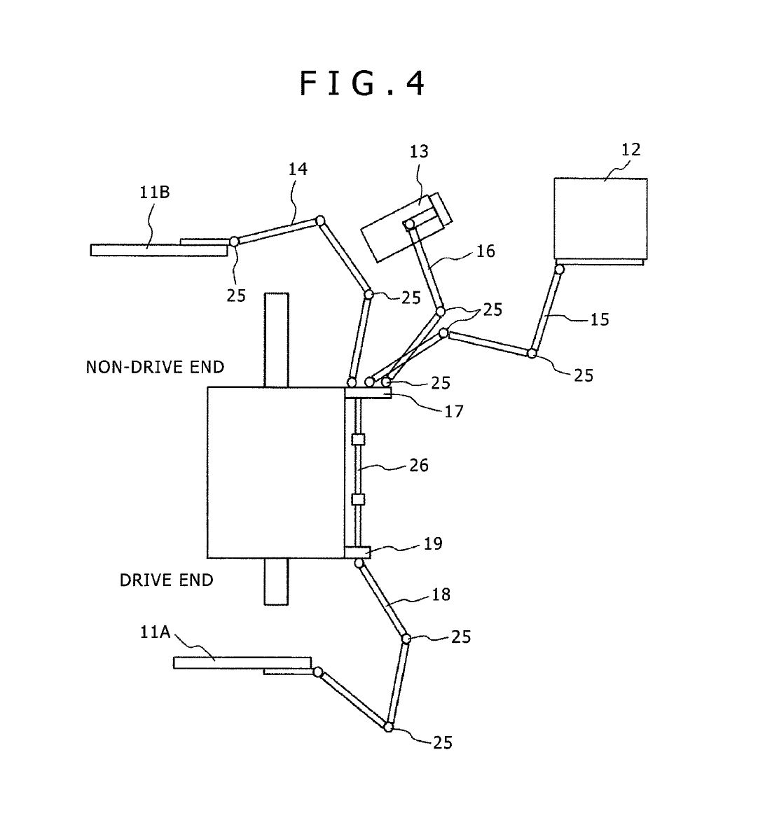

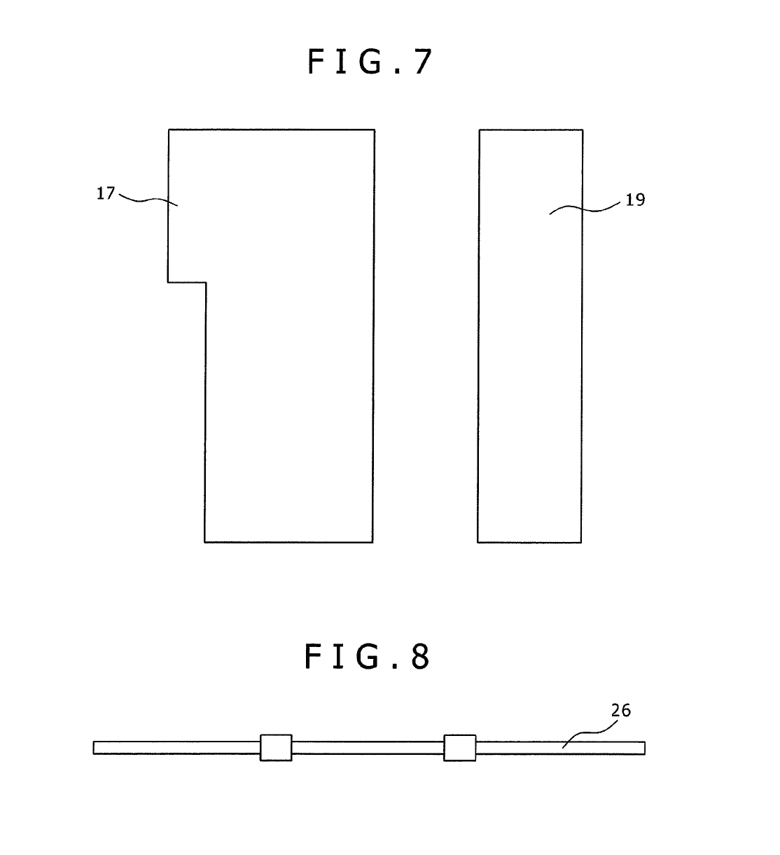

In the first embodiment of the present invention, as shown in FIG. 4, bendable arms 14, 15, 16 are mounted on a non-drive end base plate 17 (see FIG. 7) disposed on a non-drive end end portion of the generator 4, and a bendable arm 18 is mounted a drive end base plate 19 (see FIG. 7) disposed on a drive end end portion of the generator 4. More specifically, the arm 14 is used for removing the first bearing covering part 11B on the non-drive end. The arm 15 is used for removing the power supply unit outer frame 12. The arm 16 is used for removing the slipring 13. The arm 18 is used for removing the second bearing covering part 11A on the drive end. Each of these arms 14, 15, 16, 18 has a plurality of joints 25 to be described later so as to be bendable. Specifically, having the multiple joints 25, each of the arms 14, 15, 16, 18 is capable of linear and rotational motion.

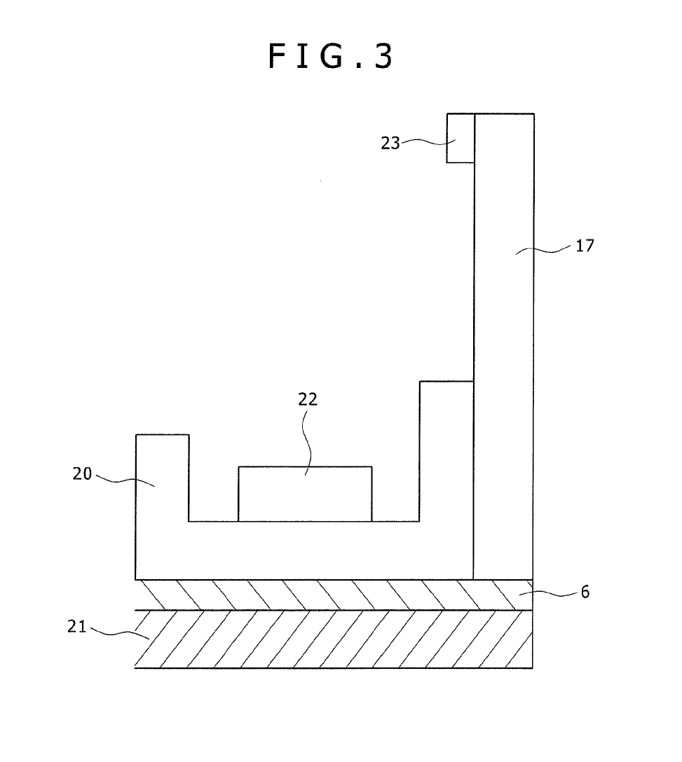

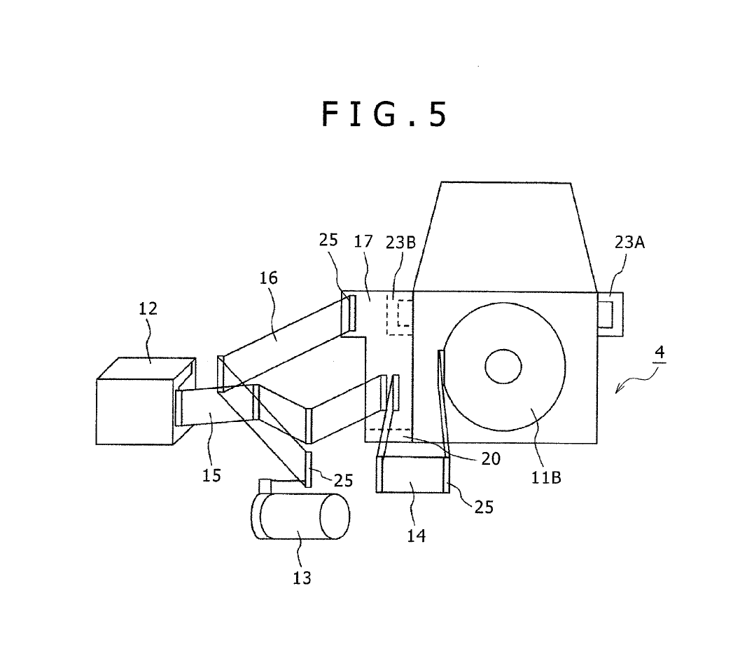

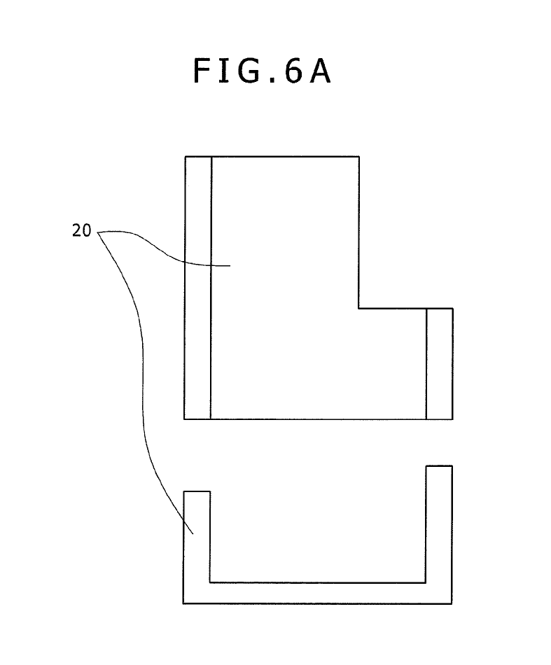

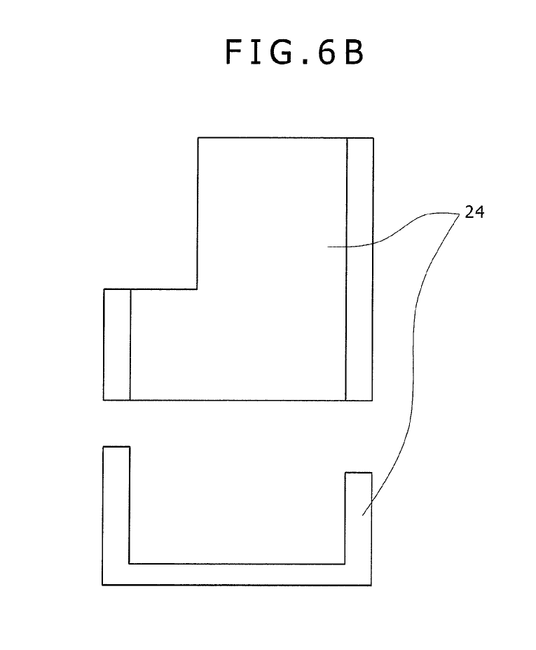

The abovementioned non-drive end base plate 17 is mounted on the generator 4 as follows. As shown in FIG. 3, an L-shaped non-drive end base 20 shown in FIG. 6A is fixed to a seat 21 to which the generator 4 is fixed on an end portion of the generator 4 via the main unit frame 6 with a bolt 22. Then, the non-drive end base plate 17 is mounted on the generator 4 using the non-drive end base 20 and a lifting tab 23B of a generator main unit. The drive end base plate 19 is mounted on the generator 4 in a similar manner by, though not shown, using an L-shaped drive end base 24 and a lifting tab 23A (see FIG. 5) of the generator main unit.

The non-drive end base 20, the non-drive end base plate 17, and the bendable arms 14, 15, 16 constitute a first maintenance jig. The non-drive end base plate 17 is mounted on the non-drive end base 20 and the lifting tab 23B of the generator main unit. The arms 14, 15, 16, mounted on the non-drive end base plate 17, are for removing the first bearing covering part 11B, the power supply unit outer frame 12, and the slipring 13, respectively. The drive end base 24, the drive end base plate 19, and the bendable arm 18 constitute a second maintenance jig. The drive end base plate 19 is mounted on the drive end base 24 and the lifting tab 23A of the generator main unit. The arm 18, mounted on the drive end base plate 19, is for removing the second bearing covering part 11A.

The non-drive end base plate 17 and the drive end base plate 19 fixed in place as described above allow the multiple arms 14, 15, 16, 18 for replacement of the bearings 10A, 10B to be mounted.

The multiple arms 14, 15, 16, 18 are mounted only during replacement of the bearings and are removed when the wind power generation system is to be operated.

FIG. 5 shows a mounting condition of the first maintenance jig described above.

When the first bearing covering part 11B, the power supply unit outer frame 12, and the slipring 13 are to be removed using the first maintenance jig, the first bearing covering part 11B needs to be removed after the power supply unit outer frame 12. Thus, the arm 14 for removing the first bearing covering part 11B is mounted on the inside of the non-drive end base plate 17 and the arm 15 for removing the power supply unit outer frame 12 is mounted on the outside of the non-drive end base plate 17. In addition, the arm 16 for removing the slipring 13 is mounted at the upper portion of the non-drive end base plate 17. Mounting the arms 14, 15, 16 at respective positions described above enables replacement of the bearing 10B without allowing each of the arms 14, 15, 16 from interfering with each other.

In the first embodiment of the present invention, the drive end base plate 19 and the non-drive end base plate 17 are connected to each other, as shown in FIG. 4, with a rod 26 as shown in FIG. 8.

Connecting the non-drive end base plate 17 and the drive end base plate 19 fixed in place with the rod 26 as described above enhances rigidity, so that steadiness can be achieved even with the arms 14, 15, 16, 18 mounted.

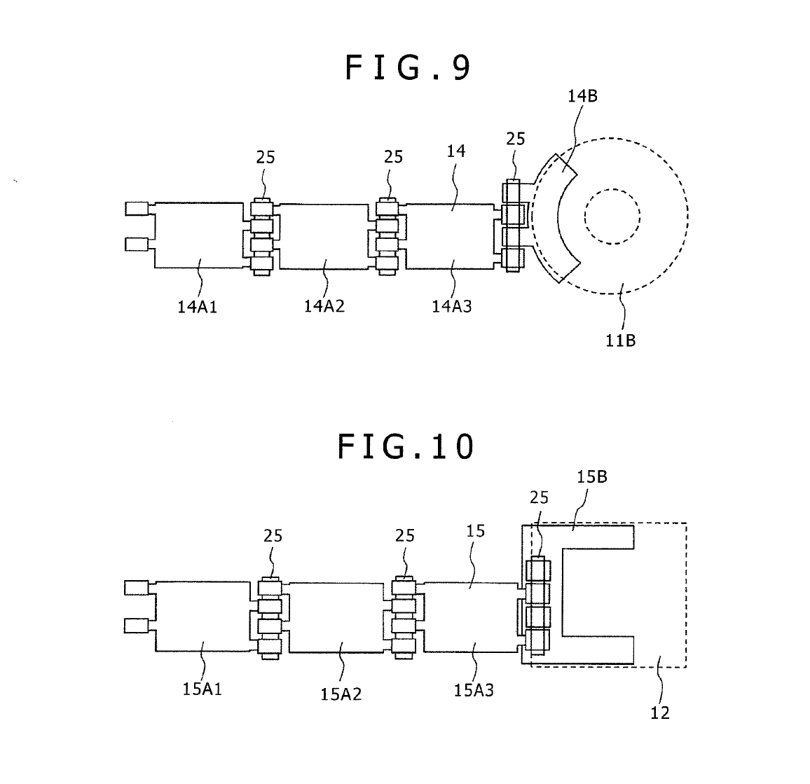

The arm 14 for removing the first bearing covering part 11B on the non-drive end, the arm 15 for removing the power supply unit outer frame 12, the arm 16 for removing the slipring 13, and the arm 18 for removing the second bearing covering part 11A on the drive end described above will now be described with reference to FIGS. 9 to 12.

FIG. 9 shows the arm 14 for removing the first bearing covering part 11B on the non-drive end.

As shown in FIG. 9, the arm 14 for removing the first bearing covering part 11B on the non-drive end includes a plurality of (three) arm hinges 14A1, 14A2, 14A3, and an arm mounting bracket 14B. The three arm hinges 14A1, 14A2, 14A3 and the arm mounting bracket 14B are connected to each other in a manner of being mutually capable of rotational and linear motion.

The arm mounting bracket 14B has a leading end shaped to match an outline shape of the first bearing covering part 11B on the non-drive end. Specifically, the arm mounting bracket 14B has a circularly arcuate leading end so as to be attached to the circular first bearing covering part 11B (both are secured in place with a bolt).

Connections between each pair of the arm hinges 14A1, 14A2, 14A3, and the arm mounting bracket 14B each have a structure capable of rotational and linear motion, thus functioning as the joints 25 of the arm 14. Moving the arm 14 axially to pull the first bearing covering part 11B out of a rotational shaft and then rotating the arm 14 allows the first bearing covering part 11B to be removed from the rotor 7.

FIG. 10 shows the arm 15 for removing the power supply unit outer frame 12 on the non-drive end of the rotor 7.

As shown in FIG. 10, the arm 15 for removing the power supply unit outer frame 12 on the non-drive end of the rotor 7 includes a plurality of (three) arm hinges 15A1, 15A2, 15A3, and an arm mounting bracket 15B. The three arm hinges 15A1, 15A2, 15A3 and the arm mounting bracket 15B are connected to each other in a manner of being mutually capable of rotational and linear motion.

The arm mounting bracket 15B has a leading end shaped to match an outline shape of the power supply unit outer frame 12. Specifically, the arm mounting bracket 15B has a leading end that is a square U-shape turned sideways so as to be attached to the box-like power supply unit outer frame 12 (both are secured in place with a bolt).

Connections between each pair of the arm hinges 15A1, 15A2, 15A3, and the arm mounting bracket 15B each have a structure capable of rotational and linear motion, thus functioning as the joints 25 of the arm 15. Moving the arm 15 axially to pull the power supply unit outer frame 12 out of a rotational shaft and then rotating the arm 15 allows the power supply unit outer frame 12 to be removed from the rotor 7.

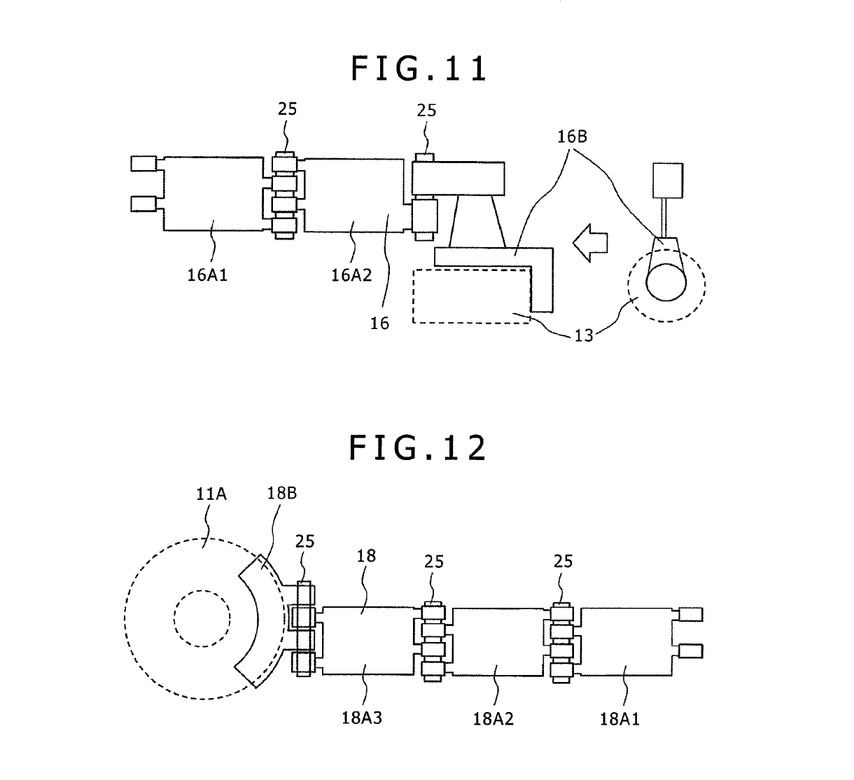

FIG. 11 shows the arm 16 for removing the slipring 13 as a part of the power supply unit of the rotor 7 on the non-drive end.

As shown in FIG. 11, the arm 16 for removing the slipring 13 as a part of the power supply unit of the rotor 7 on the non-drive end includes a plurality of (two) arm hinges 16A1, 16A2, and an arm mounting bracket 16B. The two arm hinges 16A1, 16A2 and the arm mounting bracket 16B are connected to each other in a manner of being mutually capable of rotational and linear motion.

The arm mounting bracket 16B has a leading end shaped to match an outline shape of the slipring 13. Specifically, the arm mounting bracket 16B has a circular leading end so as to be attached to the cylindrical slipring 13 (both are secured in place with a bolt).

Connections between each pair of the arm hinges 16A1, 16A2, and the arm mounting bracket 1 GB each have a structure capable of rotational and linear motion, thus functioning as the joints 25 of the arm 16. Moving the arm 16 axially to pull the slipring 13 out of a rotational shaft and then rotating the arm 16 allows the slipring 13 to be removed from the rotor 7.

FIG. 12 shows the arm 18 for removing the second bearing covering part 11A on the drive end.

As shown in FIG. 12, the arm 18 for removing the second bearing covering part 11A on the drive end includes a plurality of (three) arm hinges 18A1, 18A2, 18A3, and an arm mounting bracket 18B. The three arm hinges 18A1, 18A2, 18A3 and the arm mounting bracket 18B are connected to each other in a manner of being mutually capable of rotational and linear motion.

The arm mounting bracket 18B has a leading end shaped to match an outline shape of the second bearing covering part 11A on the drive end. Specifically, the arm mounting bracket 18B has a circularly arcuate leading end so as to be attached to the circular second bearing covering part 11A (both are secured in place with a bolt).

Connections between each pair of the arm hinges 18A1, 18A2, 18A3, and the arm mounting bracket 18B each have a structure capable of rotational and linear motion, thus functioning as the joints 25 of the arm 18. Moving the arm 18 axially to pull the second bearing covering part 11A disposed on the drive end out of a rotational shaft and then rotating the arm 18 allows the second bearing covering part 11A on the drive end to be removed from the rotor 7.

In the embodiment described above, the arms 14, 15, 16, 18 used for the removal procedure are each adapted to have a leading end shape to match the shape of a corresponding one of the first bearing covering part 11B on the non-drive end, the power supply unit outer frame 12, the slipring 13, and the second bearing covering part 11A on the drive end to be removed. If, however, a third member is inserted between the arms 14, 15, 16, 18 and the first bearing covering part 11B on the non-drive end, the power supply unit outer frame 12, the slipring 13, and the second bearing covering part 11A on the drive end, respectively, and if the third member is adapted to be shaped to match the shape of the first bearing covering part 11B on the non-drive end, the power supply unit outer frame 12, the slipring 13, and the second bearing covering part 11A on the drive end, the arms 14, 15, 16, 18 do not necessarily have a leading end shape to match the shape of the first bearing covering part 11B on the non-drive end, the power supply unit outer frame 12, the slipring 13, and the second bearing covering part 11A on the drive end.

In the first embodiment of the present invention, the arms 14, 15, 16, 18 have the joints 25 to thereby enable removal of parts in a limited space. The number of joints 25 may still be increased to make arm movements more flexible, thereby enhancing workability.

Bearing replacement methods using the first and second maintenance jigs according to the first embodiment of the present invention will be described below.

When the bearing 10B on the non-drive end of the generator 4 is to be replaced, the arms 14, 15, 16 are mounted on the non-drive end base plate 17 at an end portion of the generator 4; the first bearing covering part 11B, the power supply unit outer frame 12, and the slipring 13 are pulled out axially and removed from the generator 4 using the arm 14, the arm 15, and the arm 16, respectively; and the bearing 10B on the non-drive end is thereafter replaced with a new one in the nacelle 2.

When the bearing 10A on the drive end is to be replaced, the arm 18 is mounted on the drive end base plate 19 at an end portion of the generator 4; the second bearing covering part 11A is pulled out axially and removed from the generator 4 using the arm 18; and the bearing 10A on the drive end is thereafter replaced with a new one in the nacelle 2.

The first embodiment of the present invention as described above enables the bearing replacement procedure to be performed in a limited space inside the nacelle, achieving a considerable reduction in cost and maintenance time.

Additionally, work to disassemble various types of parts for the bearing replacement needs to be performed in the limited space available in the nacelle. Moreover, the nacelle has an extremely fragile floor having no load resistance. It is thus undesirable to place removed parts on the floor during the bearing replacement procedure. Furthermore, each part has mass that is too large for a person to carry, which necessitates assurance of safety of workers.

The first embodiment of the present invention described above enables the bearing replacement procedure to be performed in a limited space only through the mounting of the arms for removing the first and second bearing covering parts, the power supply unit outer frame, and the slipring on the generator. The first embodiment of the present invention further permits work to be completed within the generator alone without having to remove the parts from the arms. This eliminates the need for placing the parts removed from the generator on the floor, leaving load of the parts resting on the generator. In addition, the number of parts to be removed for the bearing replacement can be limited to a minimum essential number, so that the bearings on the drive end and the non-drive end can be replaced with new ones safely and within a short period of time.

It is to be noted that the present invention is not limited to the aforementioned embodiments, but covers various modifications. While, for illustrative purposes, those embodiments have been described specifically, the present invention is not necessarily limited to the specific forms disclosed. Thus, partial replacement is possible between the components of a certain embodiment and the components of another. Likewise, certain components can be added to or removed from the embodiments disclosed.

What is claimed is:

1. A bearing replacement method for a rotating machine, the method comprising the steps of:
when at least one bearing of a rotating machine is to be replaced with a new one, mounting at an end portion of the rotating machine a plurality of bendable arms for removing a first bearing covering part, a power supply unit outer frame, and a slipring, respectively;
removing with the arms the first bearing covering part, the power supply unit outer frame, and the slipring, respectively; and
thereafter replacing the at least one bearing with a new one.

2. The bearing replacement method for a rotating machine according to claim 1, wherein
the at least one bearing comprises two bearings, one being disposed on a drive end on which the rotating machine is connected to a prime mover and the other being disposed on a non-drive end opposite to the drive end,
the bearing on the non-drive end is to be replaced with a new one after the first bearing covering part, the power supply unit outer frame, and the slipring are removed with the arms, and
the bearing on the drive end is to be replaced with a new one after a bendable arm for removing a second bearing covering part is mounted on an end portion of the rotating machine and the second bearing covering part is removed with the arm.

3. The bearing replacement method for a rotating machine according to claim 2,
wherein the first bearing covering part, the second bearing covering part, the power supply unit outer frame, and the slipring are pulled out axially along the rotating machine and removed using the arms.

4. The bearing replacement method for a rotating machine according to claim 1, wherein
the rotating machine comprises a generator housed in a nacelle disposed at an upper portion in a windmill tower, and
the bearings of the generator are to be replaced with new ones in the nacelle.

5. The bearing replacement method for a rotating machine according to claim 4, wherein
the at least one bearing comprises two bearings, one being disposed on a drive end on which the rotating machine is connected to a prime mover and the other being disposed on a non-drive end opposite to the drive end,
the bearing on the non-drive end is to be replaced with a new one after the first bearing covering part, the power supply unit outer frame, and the slipring are removed with the arms, and
the bearing on the drive end is to be replaced with a new one after a bendable arm for removing a second bearing covering part is mounted on an end portion of the rotating machine and the second bearing covering part is removed with the arm.

6. The bearing replacement method for a rotating machine according to claim 5,
wherein the first bearing covering part, the second bearing covering part, the power supply unit outer frame, and the slipring are pulled out axially along the rotating machine and removed using the arms.

7. A disassembling apparatus for bearing replacement, the apparatus comprising:
a first maintenance jig including:
a base fixed via a rotating machine main unit frame to a seat to which a rotating machine is fixed, the base disposed at an end portion of the rotating machine;
a base plate fixed to the base and a lifting tab on the rotating machine main unit; and
a plurality of bendable arms to be mounted on the base plate, the arms for removing a first bearing covering part, a power supply unit outer frame, and a slipring, respectively, of the rotating machine, wherein
to replace at least one bearing of the rotating machine, the first bearing covering part, the power supply unit outer frame, and the slipring are removed using the respective arms of the first maintenance jig.

8. The disassembling apparatus for bearing replacement according to claim 7, the at least one bearing comprising two bearings, one being disposed on a drive end on which the rotating machine is connected to a prime mover and the other being disposed on a non-drive end opposite to the drive end, the disassembling apparatus further comprising:
a second maintenance jig including:
a base fixed via the rotating machine main unit frame to a seat to which the rotating machine is fixed, the base disposed at an end portion on the drive end of the rotating machine;
a base plate fixed to the base and a lifting tab on a rotating machine main unit; and
a bendable arm to be mounted on the base plate, the arm for removing a second bearing covering part, wherein
the bearing on the non-drive end is to be replaced with a new one after the first bearing covering part, the power supply unit outer frame, and the slipring are removed with the arms of the first maintenance jig, and
the bearing on the drive end is to be replaced with a new one after the second bearing covering part is removed with the arm of the second maintenance jig.

9. The disassembling apparatus for bearing replacement according to claim 8,
wherein the base plate on the drive end and the base plate on the non-drive end are connected to each other with a rod.

10. The disassembling apparatus for bearing replacement according to claim 8,
wherein the arm for removing the first bearing covering part is mounted on an inside of the base plate, the arm for removing the power supply unit outer frame is mounted on an outside of the base plate, and the arm for removing the slipring is mounted at the upper portion of the base plate.

11. The disassembling apparatus for bearing replacement according to claim 10,
wherein the base plate on the drive end and the base plate on the non-drive end are connected to each other with a rod.

12. The disassembling apparatus for bearing replacement according to claim 8, wherein
the arms each are bendably formed to comprise a plurality of arm hinges rotatably connected to each other and an arm mounting bracket rotatably connected to the arm hinges, and
the arm mounting bracket of each of the arms has a leading end shaped to match an outline shape of a corresponding one of the first bearing covering part, the second bearing covering part, the power supply unit outer frame, and the slipring.

13. The disassembling apparatus for bearing replacement according to claim 12,
wherein the base plate on the drive end and the base plate on the non-drive end are connected to each other with a rod.

14. The disassembling apparatus for bearing replacement according to claim 12,
wherein the arm for removing the first bearing covering part is mounted on an inside of the base plate, the arm for removing the power supply unit outer frame is mounted on an outside of the base plate, and the arm for removing the slipring is mounted at the upper portion of the base plate.

15. The disassembling apparatus for bearing replacement according to claim 14,
wherein the base plate on the drive end and the base plate on the non-drive end are connected to each other with a rod.

16. The disassembling apparatus for bearing replacement according to claim 7, wherein
the rotating machine comprises a generator housed in a nacelle disposed at an upper portion in a windmill tower.

17. The disassembling apparatus for bearing replacement according to claim 16, the at least one bearing comprising two bearings, one being disposed on a drive end on which the rotating machine is connected to a prime mover and the other being disposed on a non-drive end opposite to the drive end, the disassembling apparatus further comprising:
a second maintenance jig including:
a base fixed via the rotating machine main unit frame to a seat to which the rotating machine is fixed, the base disposed at an end portion on the drive end of the rotating machine;
a base plate fixed to the base and a lifting tab on a rotating machine main unit; and
a bendable arm to be mounted on the base plate, the arm for removing a second bearing covering part, wherein
the bearing on the non-drive end is to be replaced with a new one after the first bearing covering part, the power supply unit outer frame, and the slipring are removed with the arms of the first maintenance jig, and
the bearing on the drive end is to be replaced with a new one after the second bearing covering part is removed with the arm of the second maintenance jig.

18. The disassembling apparatus for bearing replacement according to claim 17,
wherein the base plate on the drive end and the base plate on the non-drive end are connected to each other with a rod.

19. The disassembling apparatus for bearing replacement according to claim 17,
wherein the arm for removing the first bearing covering part is mounted on an inside of the base plate, the arm for removing the power supply unit outer frame is mounted on an outside of the base plate, and the arm for removing the slipring is mounted at the upper portion of the base plate.

20. The disassembling apparatus for bearing replacement according to claim 19,
wherein the base plate on the drive end and the base plate on the non-drive end are connected to each other with a rod.
